(19) United States
(12) Patent Application Publication
(10) Pub. No.: US 2026/0299597 A1
(43) Pub. Date: Oct. 1, 2026

(54) METHOD AND APPARATUS FOR MOTION PLANNING FOR A ROBOT OPERATING IN A DYNAMIC ENVIRONMENT

(71) Applicant: Omron Corporation, Kyoto (JP)

(72) Inventors: Siddharth Sanan, Santa Clara, CA (US); Soma Boubou, Pleasanton, CA (US); Andres Rodriguez Campo, Dublin, CA (US); Gaurav Misra, Milpitas, CA (US); David von Edge, San Francisco, CA (US); Kazuma Tabuchi, Kyoto (JP); Sean Bailey, Emeryville, CA (US)

(21) Appl. No.: 19/096,002

(22) Filed: Mar. 31, 2025

(51) Int. Cl. G05D 1/633; G05D 111/10

(52) U.S. Cl. CPC G05D 1/633; G05D 2111/17

(57) ABSTRACT

Disclosed methods and apparatuses address scenarios involving dynamic environments and where less than all of the interest space surrounding a robot is observed for purposes of planning the motion of the robot within the interest space, based on an advantageous use of an occupancy flow process that logically creates bounding regions of “near space” (NSp) between currently seen space (CSSp) and currently unseen space (CUSp). NSp creation may also apply with respect to regions within the CSSp that are detected as occupied. The occupancy flow process uses a deterministic and mathematical propagation of probabilities of occupancy, to create logical buffer zones where motion of the robot is constrained or prohibited, despite the most recent sensor data indicating that such zones were free of obstacles. Occupancy flow processing accounts for the fact that dynamic obstacles may intrude into or move within the CSSp before the next acquisition of sensor data.

### TECHNICAL FIELD

A disclosed method and apparatus relate to motion planning for robots and particularly relate to motion planning in dynamic environments, such as environments that include humans or other robots.

### BACKGROUND

“Motion planning” in the context of robotics refers to a process of decomposing a desired movement task into discrete motions that satisfy applicable constraints on movement and possibly optimize the movement in one or more aspects.

Real-time motion planning for a robot, such as a robotic arm, within a workspace involves dynamically generating and adjusting the trajectory of the robot to accomplish tasks while reacting to changes in the environment. Such operation is essential for performing tasks such as assembly, welding, painting, or handling objects where the workspace might be cluttered, or where humans or other types of obstacles may appear unexpectedly.

Motion planning on an ongoing basis requires perception and sensing by the robot, such as by using cameras or other types of sensors for observing the workspace. The robot uses its sensor(s) to collect data on an ongoing basis and uses the data to determine the “occupancy” of its surrounding environment.

The sensor data feeds into one or more planning algorithms that are used to generate a path from a current location to a target location. Here, “location” may refer broadly to the spatial position and orientation of the robot. Trajectory generation converts the planned path into a feasible trajectory, considering the kinematic and dynamic constraints applicable to movement of the robot, along with optimization factors, such as motion smoothness, efficiency, etc. The overall process relies on continuous monitoring of the surrounding environment for new obstacles, with path recalculations performed as needed to avoid collisions, or to account for changing goals.

While motion planning by its nature involves significant complexity, operation in dynamic environments raises the complexity and stakes considerably. As used herein, a “dynamic environment” means a changing environment in which obstacles may move into or out of the “interest space” of a robot. A particular concern involves the real-time generation of motion planning policies in mixed occupancy environments, where humans and/or other robots are working or otherwise present in the same physical environment with the robot. As will be understood, a motion planning policy governs or controls motion planning.

### SUMMARY

Disclosed methods and apparatuses address scenarios where less than all of the interest space surrounding a robot is observed for purposes of planning the motion of the robot within the interest space, based on an advantageous use of an occupancy flow process that logically creates bounding regions of “near space” (NSp) between currently seen space (CSSp) and currently unseen space (CUSp). NSp creation may also apply with respect to regions within the CSSp that are detected as occupied. The occupancy flow process uses a deterministic and mathematical propagation of probabilities of occupancy, to create logical buffer zones where motion of the robot is constrained or prohibited, despite the most recent sensor data indicating that such zones were free of obstacles. Thus, the occupancy flow process accounts for the fact that dynamic obstacles may intrude into the CSSp or may move within the CSSp before the next acquisition of sensor data.

An example embodiment comprises a method of performing real-time motion planning for movement of a robot. The method includes: performing a sensor data capture in which occupancy of a first portion of the motion planning space is observed as CSSp, and a remaining, second portion of the motion planning space is unobserved as CUSp; performing an occupancy flow process to account for possible incursions of dynamic objects from the CUSp into unoccupied regions of the CSSp during a time lag between computation of an updated motion plan for the robot and corresponding incremental movement of the robot in accordance with the updated motion plan, the occupancy flow process creating one or more bounding regions of NSp at the expense of the CSSp, based on a mathematical propagation of probabilities of occupancy from the CUSp into the CSSp; updating a motion planning policy that applies one or more differentiated motion-planning parameters that are differentiated as a function of the logical classifications of the motion planning space into CUSp, CSSp, and NSp; and computing the updated motion plan for the robot, based on the updated motion planning policy.

A related example embodiment comprises a computer apparatus configured to perform real-time motion planning for movement of a robot. The computer apparatus includes interface circuitry and processing circuitry. The processing circuitry is configured to perform, via the interface circuitry, a sensor data capture in which occupancy of a first portion of the motion planning space is observed as CSSp, and a remaining, second portion of the motion planning space is unobserved as CUSp. The processing circuitry is further configured to: perform an occupancy flow process to account for possible incursions of dynamic objects from the CUSp into unoccupied regions of the CSSp during a time lag between computation of an updated motion plan for the robot and corresponding incremental movement of the robot in accordance with the updated motion plan, the occupancy flow process creating one or more bounding regions of near space (NSp) at the expense of the CSSp, based on a mathematical propagation of probabilities of occupancy from the CUSp into the CSSp; update a motion planning policy that applies one or more differentiated motion-planning parameters that are differentiated as a function of the logical classifications of the motion planning space into CUSp, CSSp, and NSp; and compute the updated motion plan for the robot, based on the updated motion planning policy.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of a robot and an associated computer apparatus, according to one embodiment.

FIG. 2 is a block diagram of example details for the robot and the computer apparatus.

FIGS. 3A-3C are diagrams of an example sensor data capture and a corresponding occupancy flow over two successive motion planning cycles, according to one embodiment.

FIG. 4 is a logic flow diagram of a method of operation by a computer apparatus for real-time motion planning for a robot, according to one embodiment.

FIG. 5 is a diagram of example periodicities for cycles of a sensor data capture procedure, in relation to corresponding cycles of occupancy propagation and motion planning procedures, according to one embodiment.

FIGS. 6 and 7 are diagrams of example rules or protocols for occupancy flow, according to respective embodiments.

FIG. 8 is a diagram of pseudocode comprising an algorithm for overall sensor data capture and motion planning, including occupancy flow, according to one embodiment.

FIGS. 9-25 are diagrams of an interest space in relation to performing the algorithm of FIG. 8 over three successive captures of sensor data, with example sensor fields of view and detected obstacles.

### DETAILED DESCRIPTION

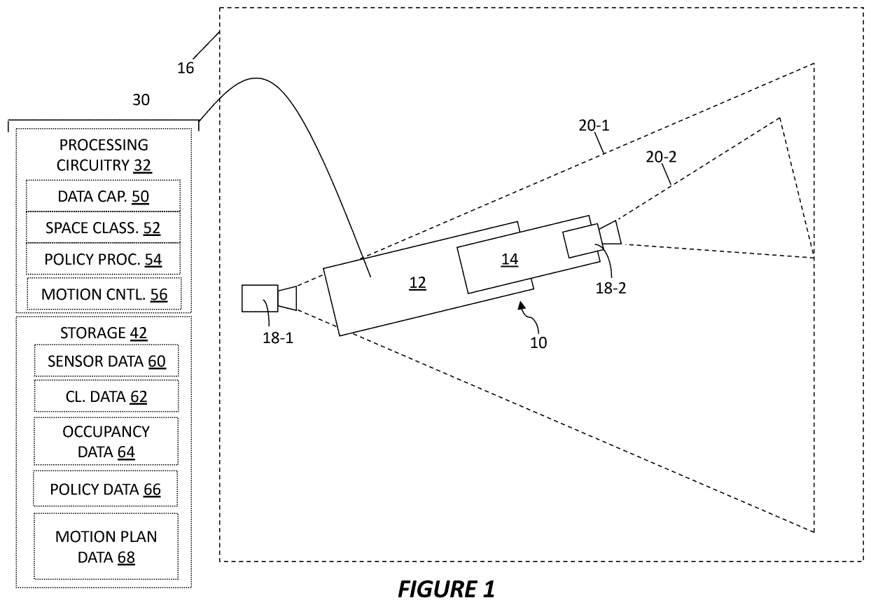

FIG. 1 illustrates a robot 10 according to one or more example embodiments, wherein the robot 10 comprises a robotic arm comprising a base 12 and one or more articulated links 14. In at least one embodiment, the base 12 comprises a mobile base; in one or more other embodiments, the base 12 is not mobile.

An interest space 16 at least partially surrounds the robot 10. As used herein, the term “interest space” refers to the physical space where occupancy is tracked or otherwise estimated with respect to planning motion of the robot 10. The interest space 16 may be unchanging or may be dynamic and it may be selected automatically, such as based on robot and sensor capabilities, or it can be set manually-configured by a system installer or operator-according to application needs. The interest space 16 is also referred to as the “motion planning space.”

One or more object detection sensors 18 provide a basis for observing the interest space 16, such as on a recurring basis, with periodic acquisitions or captures of new sensor data. There is, for example, a “frame” of sensor data acquired with each new sensor data capture.

FIG. 1 illustrates two sensors 18-1 and 18-2, where the sensor 18-1 is offboard the robot 10 and the sensor 18-2 is onboard the robot 10. The sensor 18-1 may be fixed or articulated, meaning that its corresponding field of view (FoV) 20-1 may be changing or unchanging. Similarly, the sensor 18-2 may be fixed or articulated relative to the robot 10, meaning that its corresponding FoV 20-2 may change either as a function of articulation of the sensor 18-2 or movement of portion of the robot 10 on which the sensor 18-2 is mounted. A sensor 18 may be a camera, a LIDAR sensor, or other type of sensor that provides for detection of objects within some defined detection range.

While each cycle of capturing sensor data may involve capturing data from more than one sensor 18, unless per-sensor distinctions are needed for clarity, any of the terms “sensor frame,” “sensor data frame,” or “sensor data” may be understood as broadly referring to the object detection data acquired for a given data acquisition event. It should also be understood that certain preprocessing or fusion of raw data may be needed, to obtain the “sensor data” that indicates the presence or absence of obstacles within the sensed space.

With some types of sensors, the sensor FoV encompasses less than all of the interest space 16, such that not all of the interest space 16 is sensed for any given sensor data capture event. For example, the FoV width or depth of a sensor 18 does not encompass the entire interest space 16. Additionally, or alternatively, a sensor 18 is capable of sensing the entire interest space 16, but a least a portion of its view is occluded, such that not all of the interest space 16 is visible to the sensor 18 for any given sensor data capture event. With these example scenarios in mind, it will be appreciated that any given capture of object sensing data from the sensor(s) 18 used for planning the motion of the robot 10 within the interest space 16 may result in an observed space or a “currently seen space” (CSSp) that comprises only a portion of the interest space 16. Broadly, each capture of sensor data defines the CSSp, with the remaining portion of the interest space 16 dynamically classified as “currently unseen space” (CUSp).

These classifications occur on an ongoing basis, over repeated sensor data captures, and, as detailed later herein, additional classifications may be used, all for the purpose of driving an “occupancy flow” procedure. “Occupancy propagation” may be used interchangeably with “occupancy flow.”

In its simplest form, occupancy flow may be understood as an intelligent way of propagating probabilities of occupancy into unoccupied regions of CSSp, to account for the possible intrusion of dynamic obstacles from the CUSp into the CSSp and/or the movement of dynamic obstacles within the CSSp. This propagation or flow of occupancy creates one or more bounding regions of “near space” (NSp) at the expense of the CSSp, with the motion planning policy used for motion planning of the robot 10 updated to account for differentiated motion planning with respect to NSp versus CSSp.

In a simple but important example, occupancy propagation means propagating probabilities of occupancy from the CUSp into unoccupied regions of the CSSp and/or propagating detected occupancies corresponding to objects in the CSSp that are classified or otherwise known to be dynamic into surrounding, unoccupied regions of the CSSp. Logical creation of the NSp thus comes at the expense of unoccupied regions of the CSSp, meaning that as NSp grows, the CSSp shrinks.

By differentiating between NSp and CSSp in the motion planning policy, the generated motion plan and corresponding movement of the robot 10 is differentiated for CSSp versus NSp. For example, a maximum movement speed may be set lower for NSp than for unoccupied regions of the CSSp, such that the robot 10 moves slower (or avoids) NSp. In this sense, the one or more bounding regions of NSp created by the occupancy flow process can be understood as safety regions or buffer zones that account for the possibility of dynamic objects moving into or within the CSSp subsequent to the sensor data capture that defines the CSSp.

Broadly, the disclosed methods and configurations exploit logical classifications of the interest space, among other things, in a manner that advantageously addresses the issues arising when performing motion planning in instances where the sensed space does not encompass the entirety of the space implicated in the planning operation. In particular, these methods and configurations account for the challenges that arise in cases where dynamic objects, such as humans or other robots, may be present within the interest space. The logical creation of NSp can be understood as an advantageous, deterministic basis for creating what, in one or more embodiments, may be regarded as safety regions where the robot 10 moves more slowly, for example, or avoids entering.

In an example embodiment, a computer apparatus 30 is configured to perform real-time motion planning for movement of a robot 10. The computer apparatus 30 may be onboard the robot 10 or offboard. In one or more embodiments, the computer apparatus 30 comprises an offboard computer server having access to data from the sensor(s) 18 and having wired or wireless communication link with the robot 10. In one or more other embodiments, the computer apparatus 30 is onboard the robot 10, e.g., implemented as part of or in association with an embedded processing and control system carried onboard the robot 10 for operational control of the robot 10.

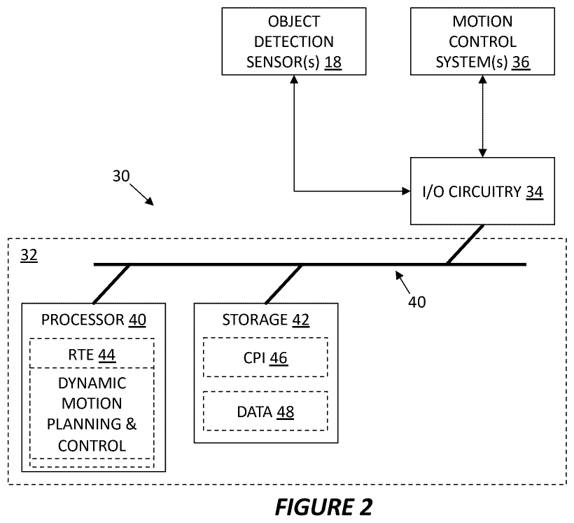

FIG. 2 offers example details for the computer apparatus 30 in an onboard variant, where the computer apparatus 30 includes processing circuitry 32 and associated input/output circuitry 34 (“interface circuitry 34”). The interface circuitry 34 couples the processing circuitry 32 with one or more object detection sensors 18, and with one or more motion control systems 36 of the robot 10. The motion control system(s) 36 are also referred to as a “motion actuation system” and include, in at least one embodiment, one or more drive motors for movement and directional control of the robot 10 within the interest space, with the processing circuitry 32 configured to output motor control signals for corresponding control of the motion actuation system 36.

The processing circuitry 32 in an example embodiment comprises a processor 40 and associated storage 42. The processor 40 comprises, for example, one or more microprocessors, microcontrollers, digital signal processors, or other digital processing circuitry, such as one or more Field Programmable Gate Arrays (FPGAs) or Application Specific Integrated Circuits (ASICs) that implement a programmable digital processor. In at least one example, the processor 40 provides a runtime environment 44 for the execution of one or more computer programs. In at least one embodiment, the storage 42 comprises one or more types of computer readable media, such as a mix of volatile and non-volatile memories.

The storage 42 contains computer program instructions (CPI) 46, the execution of which by the processor 40 configures—specially adapts—the processor 40 to carry out the method(s) described herein for real-time motion planning for the robot 10. In at least one such example, the CPI 46 constitute a dynamic motion planning and control program that is executed by the processor 40. The storage 42 in one or more embodiments also stores data 48, where the data 48 comprises configuration data (provisioned data) and/or operational data—working data—determined on the fly, as part of live program execution.

Turning back to FIG. 1, the processing circuitry 32 implements or instantiates a number of logical processing modules or units, where these processing units shall be understood as functional logic implemented, for example, via the execution of computer program instructions on physical processing circuitry. Example processing units include a data capture module 50 configured for capture and/or preprocessing of sensor data from the one or more sensors 18, a space classification module 52 configured for dynamic classification (segmentation) of the interest space 16 as described herein, a motion policy processing module 54 configured for generating or updating a motion planning policy on a differentiated basis that accounts for the dynamic segmentation of the interest space 16, and a motion control module 56 configured to generate a motion path for the robot 10 according to the differentiated motion planning policy.

Corresponding “live” or “working” data held in the storage 42 includes sensor data 60, space classification data 62, occupancy data 64, policy data 66, and motion planning data 68. The sensor data 60 may be in raw and/or processed forms and may include both the current or most recent capture of data from the one or more sensors 18, as well as historic or aged data, such as one or more prior data captures. In at least one embodiment, every point in the interest space 16 is associated with or represented by a corresponding occupancy value and one or more time values that indicate whether or when sensor data were last captured for that point. In at least one such embodiment, the processing uses a voxelization of the interest space 16, which subdivides the interest space 16 into a plurality of unit-sized three-dimensional regions. With such approaches, the overall volume defined by the interest space 16 is represented in the processing domain as a plurality of voxels, with each voxel having associated parameters, the values of which identify its current space classification, its current occupancy value, and a timestamp indicating whether or when sensor data was last captured for the voxel.

In general terms, the classification data 62 represents the current space classifications by which the interest space 16 is logically segmented for policy differentiation and corresponding motion planning. The occupancy data 64 comprises for example, detected occupancy in the CSSp, assumed or previously detected occupancy in the CUSp, and propagated occupancy in the NSp, as provided by the occupancy flow processing.

Occupancy may be represented for any point in the interest space 16 as a numeric value reflecting the probability of occupancy at that point. In this approach, a point in the CSSp for which the presence of an obstacle was detected may be assigned a probability of occupancy of one (“1”), while a point in the CSSp for which no obstacle was detected may be assigned a probability of occupancy of zero (“0”). Points subjected to the occupancy flow processing may take on propagated occupancy values, such as intermediate probabilities between 0 and 1. The propagated value depends, for example, on the starting value of the occupancy being propagated, and, in one or more embodiments, the propagated value at any given point involved in the occupancy flow increases with successive iterations of the flow process, such that higher probabilities of occupancy attain over time.

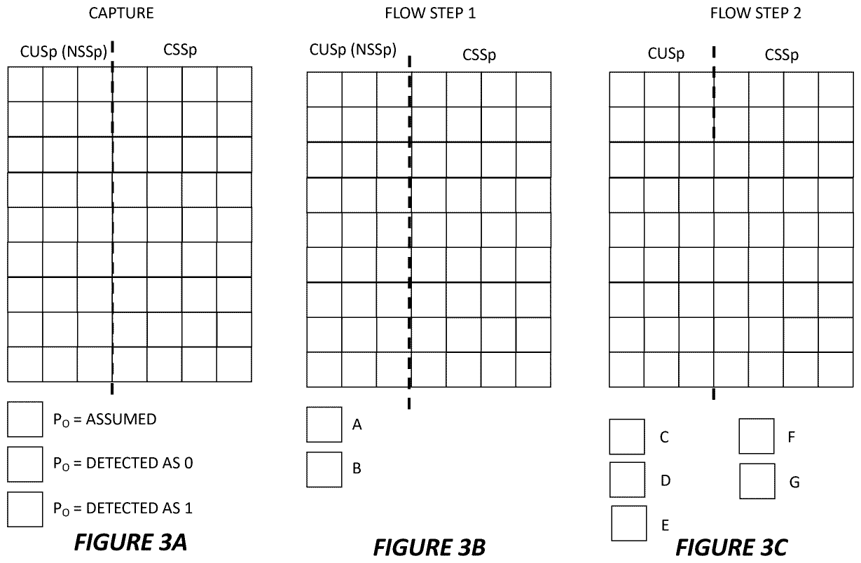

FIGS. 3A, 3B, and 3C illustrate example occupancy flow, in a simplified case where the CUSp comprises “never seen space” (NSSp), meaning that the points comprised within the CUSp have never been sensed or have not been sensed within some defined aging period—i.e., in one or more embodiments, any given region of the interest space 16 may be seen via a given sensor data capture and then not seen again for some number of successive sensor data captures. For one or more such successive sensor data captures, that given region may be treated as “previously seen space” (PSSp), with that PSSp reverting back to NSSp unless re-sensed within some defined number of sensing periods of other measured time limit.

In any case, FIG. 3A assumes that a sensor data capture just happened, with the interest space 16 cleanly segmented into CUSp and CSSp. The region(s) of the interest space 16 that were sensed via the sensor data capture comprise the CSSp, with everything else being CUSp, which, in this simplified example is assumed to be comprised entirely of NSSp—i.e., there are no regions of PSSp within the CUSp. All regions or portions of the CUSp are assigned a default occupancy probability, e.g., a probability of 0.5, reflecting the uncertainty about whether obstacles are or are not present in the CUSp.

Occupancy probabilities for the CSSp on the other hand are set based on what is indicated by the captured sensor data. In this example, all regions of the CSSp were detected as unoccupied, except for one region at which an obstacle was detected. The square subdivisions or blocks shown in FIGS. 3A, 3B, and 3C may be voxels in one or more embodiments, although it should be understood that a much finer voxel granularity may be used in practice. Also, note that if the sensor data captured during any given capture operation does not completely account for all of a given voxel, that voxel may be deemed to be unseen. That is, the dynamic space classification may be applied at the voxel granularity.

FIG. 3B shows a first occupancy flow step applied after the most recent-current-sensor data capture, which occurred in FIG. 3A. The first flow step “consumes” portions of the CSSp, converting those consumed portions into NSp. In particular, occupancy flows across the boundary between the CUSp and the CSSp, with the correspondingly consumed voxels marked as “A” in the diagram. Such flow represents the propagation of occupancy from bounding regions of CUSp into unoccupied regions of CSSp (occupancy flow does not overwrite detected occupancy in the CSSp). These “A” voxels have, for example, an occupancy value that is a fraction—e.g., half—of the occupancy value being propagated from the bounding voxels.

Further, assuming that the detected obstacle in the CSSp is classified as a dynamic obstacle, this first step of the occupancy flow also propagates occupancy from the voxel(s) that contain the detected obstacle into the neighboring voxels. These affected voxels are marked “B” in the diagram. The “A” voxels distinguish from the “B” voxels in the sense that the occupancy value being propagated into the “A” voxels may be a default or assumed value, whereas the occupancy value being propagated into the “B” voxels is a detected value. Thus, at flow step 1, the probability of occupancy set in the A voxels may differ numerically than the probability of occupancy set in the B voxels. In either case, however, the propagated value may be a fraction of the starting value. It should be understood that these A and B voxels constitute the bounding regions of NSp created via the first flow step.

The result of the first flow step is the creation of bounding regions of NSp at the expense of the unoccupied regions of the CSSp, with these bounding regions creating a safety zone or buffer at the boundary/boundaries with the CUSp and with respect to each dynamic obstacle detected in the CSSp. Here, it may be noted that a detected obstacle may be classified as dynamic based on any one or more of: configuration data, obstacle recognition processing, or obstacle tracking from successive sensor data captures.

Motion planning, including motion policy updating and corresponding motion path generation may be performed based on the results of flow step 1, and then again for the results of flow step 2, which is shown in FIG. 3C. Here, it should be understood that the sensor data capture that happened in the context of FIG. 3A is the current (most recent) sensor data capture for both flow steps 1 and 2, such that the second flow step is a further propagation cycle applied to the previous or initial occupancy flow propagation seen in flow step 1.

In more detail, the second flow step propagates the occupancy value of the A voxels into the next neighboring unoccupied voxels remaining in the CSSp, to create “D” voxels, and updates (increases) the occupancy value of the A voxels, to create C voxels. Similarly, the second flow step propagates the occupancy value of the B voxels into the next neighboring unoccupied voxels remaining in the CSSp, to create “G” voxels, and updates the occupancy value of the B voxels to create “F” voxels.

Further in this example, the occupancy flow associated with the bounding CUSp interacts with the occupancy flow from the occupied region of CSSp, such that the propagated occupancy value for one or more voxels of the CSSp that are converted into NSp have a value that represents the interaction of the two occupancy flows-see the “E” voxels in FIG. 3C, which are the result of the occupancy propagation from the A voxels and the B voxels in FIG. 3B.

With such examples in mind, in one or more embodiments a computer apparatus 30 comprises interface circuitry 34 and processing circuitry 32. The processing circuitry 32 is configured to: (i) perform, via the interface circuitry, a sensor data capture in which occupancy of a first portion of a motion planning space is observed as CSSp, and a remaining, second portion of the motion planning space is unobserved as CUSp; (ii) perform an occupancy flow process to account for possible incursions of dynamic objects from the CUSp into unoccupied regions of the CSSp during a time lag between computation of an updated motion plan for the robot and corresponding incremental movement of the robot 10 in accordance with the updated motion plan, the occupancy flow process creating one or more bounding regions of NSp at the expense of the CSSp, based on a mathematical propagation of probabilities of occupancy from the CUSp into the CSSp; (iii) update a motion planning policy that applies one or more differentiated motion-planning parameters that are differentiated as a function of the logical classifications of the motion planning space into CUSp, CSSp, and NSp; and (iv) compute the updated motion plan for the robot 10, based on the updated motion planning policy. Here, the “motion planning space” may be an interest space 16 as described above.

The processing circuitry 32 in one or more embodiments is configured to move the robot 10 in the motion planning space according to the updated motion plan, based on being configured to drive one or more motion actuation systems of the robot 10 according to values of the one or more motion planning parameters that are differentiated as between movement within the CSSp versus movement within any of the one or more bounding regions of NSp. For example, the one or more differentiated motion-planning parameters include a speed parameter having a first value applicable to movement of the robot 10 in the CSSp, and a lower, second value applicable to movement of the robot 10 in the NSp, and wherein the processing circuitry 32 is configured to apply the second value of the speed parameter when moving the robot 10 in the NSp.

For computing the updated motion plan for the robot 10, the processing circuitry 32 in one or more embodiments is configured to determine whether or to what extent an overall motion path for the robot 10 includes any of the one or more bounding regions of NSp, based on balancing an overall path traversal time against one or both of path distance and path complexity. As a particular example, the updated motion planning policy includes using a slower maximum speed for movement of the robot 10 within the NSp, as compared to a maximum speed allowed for the robot 10 within unoccupied regions of the CSSp. As such, the updated motion plan may be based on minimizing how much of the planned path for the robot 10 passes through any of the one or more bounding regions of NSp. Alternatively, the updated motion planning policy may include a prohibition of movement within the NSp, such that the planned path excludes the one or more bounding regions of NSp.

Broadly, in one or more embodiments, the one or more differentiated motion planning parameters comprise a motion planning parameter having a first value associated with the CSSp, the first value allowing movement of the robot 10 within the CSSp (meaning regions of CSSp detected as unoccupied) and having a second value associated with the one or more bounding regions of NSp. The second value disallows movement of the robot within the one or more bounding regions of NSp. For computing the updated motion plan for the robot 10 in this example, the processing circuitry 32 is configured to determine a motion path that is constrained to movement within the CSSp—i.e., the processing circuitry 32 is configured to recognize that the second value of the parameter disallows movement within the NSp.

In at least one embodiment, the processing circuitry 32 is further configured to: classify any particular region in the CSSp as an occupied region or an unoccupied region, in dependence on corresponding sensor data captured for that particular region, and classify each occupied region as being dynamic or static, in dependence on one or both of configuration data and historical sensor data obtained from prior performances of sensor data capture. Here, for creating the one or more bounding regions of NSp, the processing circuitry 32 is further configured to, for each dynamic region in the CSSp, create a corresponding bounding region of NSp that partially or wholly surrounds the dynamic region.

The processing circuitry 32 in one or more embodiments is configured to classify regions of the CUSp as NSSp or as PSSp, in dependence on whether or how recently sensor data was captured with respect to such regions. Correspondingly, the occupancy flow process differentiates between NSSp and PSSp in that the probabilities of occupancy for NSSp depend on a configured default probability of occupancy, while probabilities of occupancy for each PSSp depend on observed occupancies determined from a most recent capture of sensor data performed with respect to the corresponding region.

In one or more embodiments, the processing circuitry 32 is configured to perform the sensor data capture as one iteration of a cyclic data capture procedure that is performed on an ongoing basis and perform the occupancy flow process as one iteration of a cyclic occupancy propagation procedure that is performed on an ongoing basis. Each new iteration of the cyclic data capture procedure establishes a new CSSp that persists as a current CSSp until the next iteration of the cyclic data capture procedure, and wherein each new iteration of the cyclic occupancy propagation procedure acts on the current CSSp. Further, for updating the motion planning policy, the processing circuitry 32 in at least one such embodiment is configured to perform one iteration of a cyclic motion planning procedure, and each iteration of the cyclic occupancy propagation procedure is accompanied by a corresponding iteration of the cyclic motion planning procedure. A periodicity of the cyclic motion planning procedure and the cyclic occupancy propagation procedure is faster than a periodicity of the cyclic data capture procedure, in at least one such embodiment. With this periodicity relationship, the current CSSp is subjected to two or more successive iterations of the cyclic occupancy propagation procedure, with each succeeding iteration growing the one or more bounding regions of NSp at the expense of the current CSSp. FIG. 3 offered one example of this approach, showing flow steps 1 and 2, applied successively with respect to one sensor data capture.

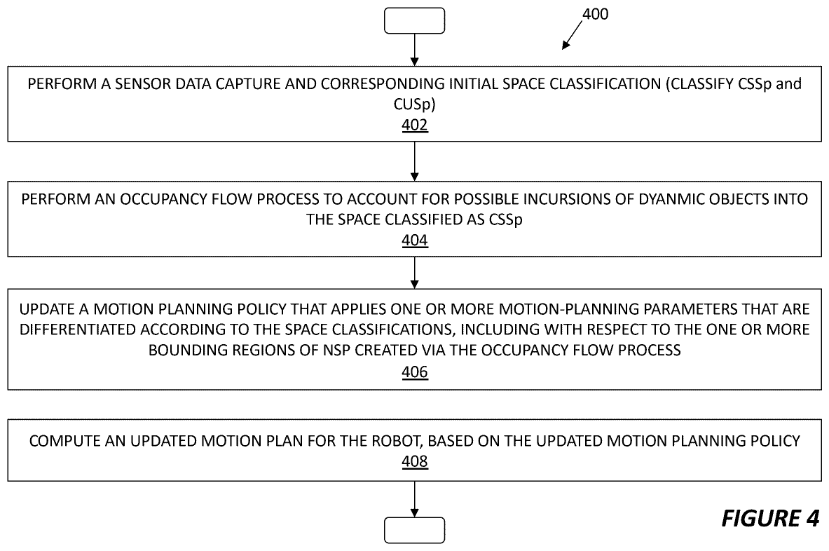

FIG. 4 illustrates an example method 400 of performing real-time motion planning for movement of a robot 10. In one or more example embodiments, a computer apparatus 30 such as illustrated in FIG. 1 is configured to carry out the method 400.

In the illustrated example, the method 400 includes: performing (Block 402) a sensor data capture in which occupancy of a first portion of a motion planning space of a robot 10 is observed as CSSp, and a remaining, second portion of the motion planning space is unobserved as CUSp; performing (Block 404) an occupancy flow process to account for possible incursions of dynamic objects from the CUSp into unoccupied regions of the CSSp during a time lag between computation of an updated motion plan for the robot 10 and corresponding incremental movement of the robot 10 in accordance with the updated motion plan, the occupancy flow process creating one or more bounding regions of NSp at the expense of the CSSp, based on a mathematical propagation of probabilities of occupancy from the CUSp into the CSSp; updating (Block 406) a motion planning policy that applies one or more differentiated motion-planning parameters that are differentiated as a function of the logical classifications of the motion planning space into CUSp, CSSp, and NSp; and computing (Block 408) the updated motion plan for the robot, based on the updated motion planning policy.

In one or more embodiments, the method 400 further includes moving the robot 10 in the motion planning space according to the updated motion plan. Moving the robot 10 in the motion planning space according to the updated motion plan comprises, for example, driving one or more motion actuation systems of the robot 10 according to values of the one or more motion planning parameters that are differentiated as between movement within the CSSp versus movement within any of the one or more bounding regions of NSp.

In at least one embodiment, the one or more differentiated motion-planning parameters include a speed parameter having a first value applicable to movement of the robot in the CSSp, and a lower, second value applicable to movement of the robot in the NSp. In such embodiments, the method 400 includes applying the second value of the speed parameter when moving the robot in the NSp.

Computing the updated motion plan for the robot 10 (Block 408) comprises, for example, determining whether or to what extent an overall motion path for the robot 10 includes any of the one or more bounding regions of NSp, based on balancing an overall path traversal time against one or both of path distance and path complexity.

In at least one embodiment or according to at least one operational example, the one or more differentiated motion planning parameters comprise a motion planning parameter having a first value associated with the CSSp, the first value allowing movement of the robot 10 within the CSSP and having a second value associated with the one or more bounding regions of NSp, the second value disallowing movement of the robot 10 within the one or more bounding regions of NSp. Correspondingly, computing the updated motion plan for the robot 10 (Block 408) comprises determining a motion path that is constrained to movement within the CSSp.

In at least one embodiment, the method 400 includes classifying any particular region in the CSSp as an occupied region or an unoccupied region, in dependence on corresponding sensor data captured for that particular region, and classifying each occupied region as being dynamic or static, in dependence on one or both of configuration data and historical sensor data obtained from prior performances of sensor data capture. Correspondingly, the step or process of creating the one or more bounding regions of NSp further comprises, for each dynamic region in the CSSp, creating a corresponding bounding region of NSp that partially or wholly surrounds the dynamic region. Further in this context, updating the motion planning policy comprises setting a particular motion planning parameter to a first value for occupied regions in the CSSp, and to a second value for unoccupied CSSp.

In at least one embodiment, the method 400 includes assigning an occupancy probability of 1 to each dynamic region in the CSSp. As such, the corresponding bounding region of NSp has a probability of occupancy derived from the occupancy of probability of 1. That is, the occupancy flow processing described herein propagates the occupancy value of 1 outward from the dynamic region, with that outward propagation consuming CSSp.

Note that the outward propagation affects only those points in the bounding CSSp that were detected as unoccupied. This approach offers a deterministic, mathematical basis for converting an unoccupied region bounding a dynamically occupied region into a buffer zone, which, correspondingly, allows motion planning and path determination to be differentiated for such buffer zones in comparison to “normal” unoccupied CSSp.

One or more embodiments of the method 400 include classifying regions of the CUSp as NSSp or as PSSp, in dependence on whether or how recently sensor data was captured with respect to such regions. Performing the occupancy flow process in such embodiments includes differentiating between NSSp and PSSp, in that the probabilities of occupancy for NSSp depend on a configured default probability of occupancy, while probabilities of occupancy for each PSSp depend on observed occupancies determined from a most recent capture of sensor data performed with respect to the corresponding region.

Performing the above-described sensor data capture in one or more embodiments comprises performing one iteration of a cyclic data capture procedure that is performed on an ongoing basis. Correspondingly, performing the occupancy flow process comprises performing one iteration of a cyclic occupancy propagation procedure performed on an ongoing basis, with each new iteration of the cyclic data capture procedure establishing a new CSSp that persists as a current CSSp until the next iteration of the cyclic data capture procedure, and with each new iteration of the cyclic occupancy propagation procedure acting on the current CSSp.

Extending this periodic processing, updating the motion planning policy in one or more embodiments comprises performing one iteration of a cyclic motion planning procedure. Here, each iteration of the cyclic occupancy propagation procedure is accompanied by a corresponding iteration of the cyclic motion planning procedure. In at least one such embodiment, the periodicity of the cyclic motion planning procedure and the cyclic occupancy propagation procedure is faster than a periodicity of the cyclic data capture procedure, such that the current CSSp is subjected to two or more successive iterations of the cyclic occupancy propagation procedure, with each succeeding iteration growing the one or more bounding regions of NSp at the expense of the current CSSp.

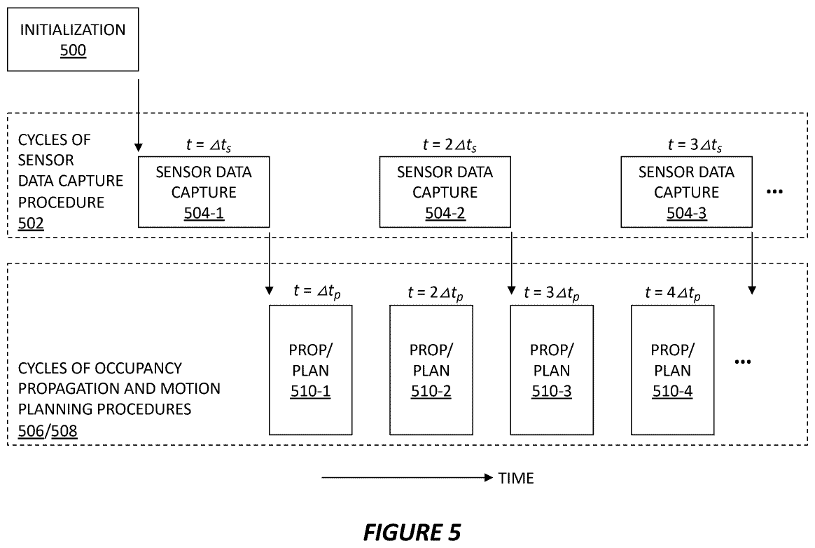

FIG. 5 illustrates an example of runtime operational logic and associated periodicities consistent with the foregoing examples. Operation begins with an initialization step or operation 500, in which the data structures and logic associated with observing and classifying the interest space 16 are zeroed or otherwise initialized.

A sensor data capture procedure 502 begins executing periodically, such that there are captures of new sensor data at regular intervals marked as capture 504-1, 504-2, 504-3, and so on. Capture 504-1 occurs at time t=Δtₛ, capture 504-2 occurs at time t=Δtₛ, capture 504-3 occurs at time t=Δtₛ, and so on. Each data capture defines a respective CSSp, and the occupancy of all points contained within the CSSp is set in accordance with the corresponding sensor data.

According to the relative periodicities illustrated in FIG. 5, each CSSp is subjected to two cycles of occupancy propagation and motion planning procedures 506 and 508. For the CSSp defined by capture 504-1, a first iteration of occupancy flow occurs at t=Δtₚ, which falls just after capture 504-1 and the corresponding initial segmentation of the interest space 16 into CSSp and CUSp, in dependence on portion(s) of the interest space 16 are represented in capture 504-1. Thus, the prop/plan operations 510-1 can be understood as the initial creation of one or more bounding regions of NSp at the border between CUSp and CSSp, and around any obstacles that are detected in the CSSp and classified as dynamic.

The prop/plan operations 510-2 extend the occupancy flow and update the motion planning, with respect to the CSSp defined by capture 504-1. The prop/plan operations 510-3 represent initial occupancy flow and motion planning undertaken with respect to the new CSSp defined by capture 504-2. The prop/plan operations 510-4 extend the occupancy flow and update the motion planning, with respect to the CSSp defined by capture 504-2.

As explained before, the occupancy flow does not override occupancy values corresponding to detected objects. Instead, with respect to the CSSp, occupancy flow is a process whereby unoccupied neighboring points or voxels in the CSSp are deterministically and mathematically converted to NSp, which allows differentiated motion planning policies and, correspondingly, differentiated motion planning and movement. The differentiation can be understood as applying an additional restraint for moving the robot 10 when close to the border between CSSp and CUSp and/or when close to any object that is detected in the CSSp and classified as dynamic.

A nice way to view this approach is that the robot 10 can be made to avoid boundary regions of the CSSp, or move more slowly in such regions, even though they were detected as unoccupied. This differentiated treatment reflects the fact that obstacles may intrude or otherwise move into these bounding regions after the data capture.

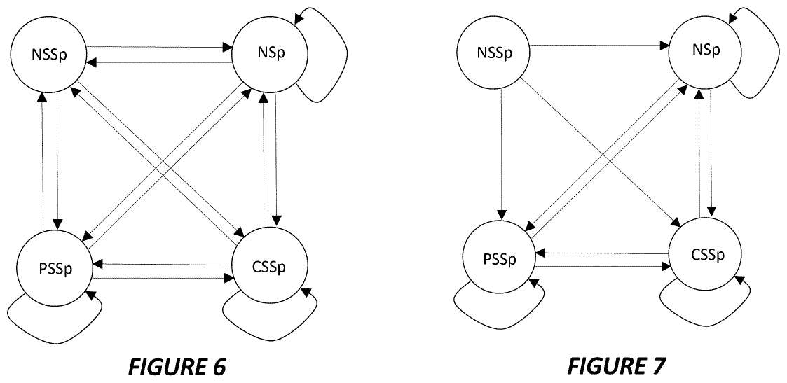

FIG. 6 provides a graphical illustration of occupancy flow rules or definitions according to one embodiment. According to FIG. 6 occupancy flow can be between all logical classes of space, where those classifications include PSSp, NSSp, CSSp, and NSp. Here, it should be understood that PSSp and NSSp are subclassifications of CUSp. FIG. 6 also illustrates that occupancy flow may be within PSSp, within CSSp, and within NSp. In all instances, “flowing” occupancy refers to the mathematical process of advancing a detected or assumed occupancy from one or more starting points incrementally, as an advancing “wavefront” within the logical representation of the interest space 16, to account for the fact that in an environment with dynamic obstacles, newly acquired sensor data starts becoming stale the instant it is acquired.

FIG. 7 offers a slight variation on the scheme represented in FIG. 6, wherein occupancy does not flow into NSSp. Of course, this variations is but one example simplification and other simplifications are possible. For example, a further simplification is not to carry out occupancy flow from PSSp into NSp, or not to carry out occupancy flow from CSSp into PSSp.

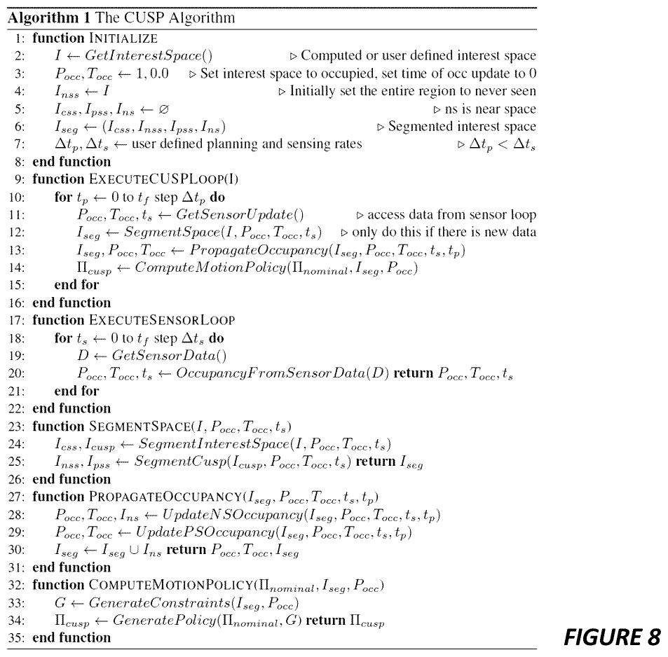

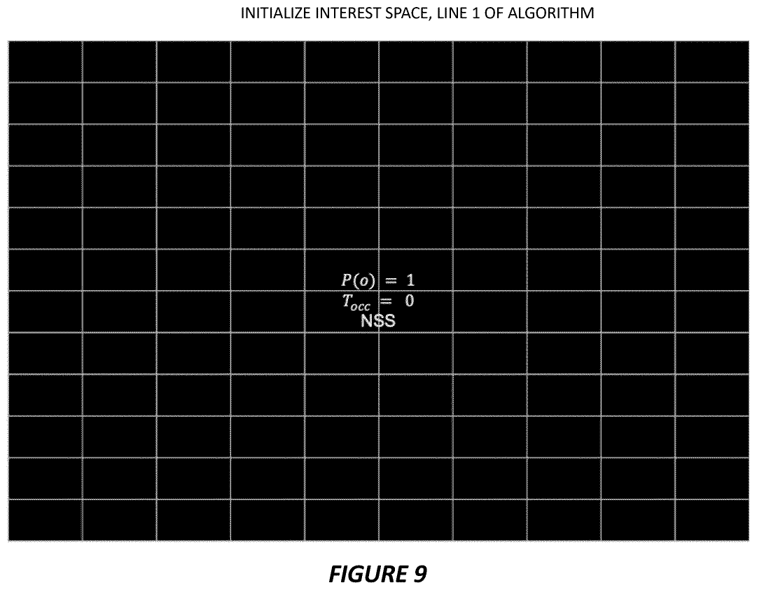

FIG. 8 illustrates an example algorithmic procedure for carrying out motion planning in consideration of occupancy flow and FIGS. 9-25 provide graphical illustrations of the processing operations and results associated with corresponding line numbers in the pseudo code presented in FIG. 8. In this context, there are two occupancy propagation and cyclic motion planning procedures for each cyclic data capture procedure.

FIGS. 9-25 represent a simplified example in which a given interest space is represented as a rectangular array of blocks or cells. There are three successive sensor data captures represented over FIGS. 9-25, with each data capture premised on the idea that the left half of the interest space is never seen, and that the right half of the interest space is fully or at least partly seen in each sensor data capture. This simplified example is non-limiting and it shall be understood that there may be much more complex combinations of seen and unseen space with respect to any one or more sensor data captures, but the same space-segmentation and occupancy flow logic holds for these more complex scenarios.

FIG. 9 illustrates the initialization of an interest space, in a logical, processing-domain sense. The cells shown as subdivisions of the interest space may be understood as voxels or other uniform volumetric units that represent the atomic units of space according to which occupancy values are maintained. As an initial operation and before the beginning of sensor data acquisition, the whole interest space may be classified uniformly as NSSp. The starting occupancy presumption for NSSp may be a configurable value or may be hard-coded.

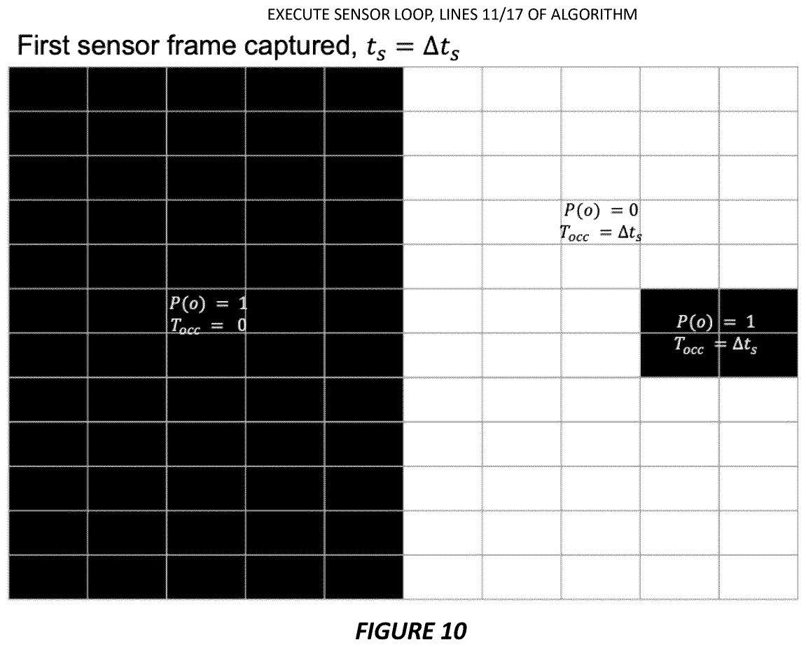

In FIG. 9 and likewise in FIGS. 10-25, a black cell indicates an occupancy probability value of 1—i.e., occupied—while a white cell indicates an occupancy probability value of 0—i.e., not occupied. FIG. 9 can thus be understood as an example case where the interest space is initialized as NSSp with all NSSp cells having a probability of occupancy of 1. Of course, less pessimistic initializations may be used but, in any case, the time at which this occupancy assumption—these occupancy values—is applied is noted as T_{occ}, where T_{occ} is initialized to 0.

FIG. 10 depicts the results of a first sensor frame being captured for the interest space 16. Here, “sensor frame” refers to the data collected via one capture event and it may be a camera image, a LIDAR scan set, etc. FIG. 10 assumes that the first sensor frame contains data only for the right half of the depicted interest space 16. Because the left half of the interest space was not sensed, the left-half cells retain the initialized occupancy value. However, the cells that are represented in the sensor frame have their probabilities of occupancy set in accordance with the actual sensor data.

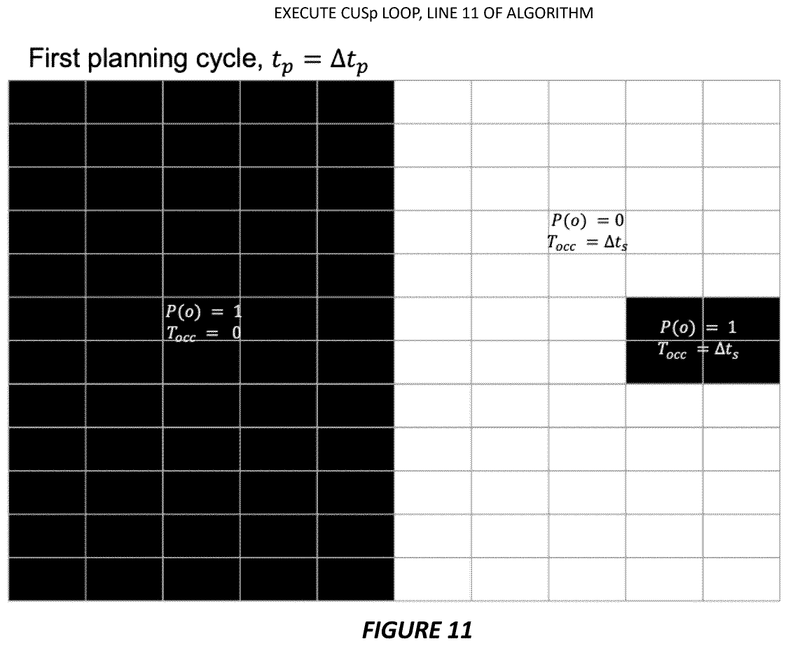

The time of occupancy T_{occ} and the per cell probability of occupancy is updated for all cells represented in the data capture—i.e., for all cells included in the CSSp. FIG. 11 depicts the passing of this first frame of sensor data into the CUSp loop, for motion planning operations.

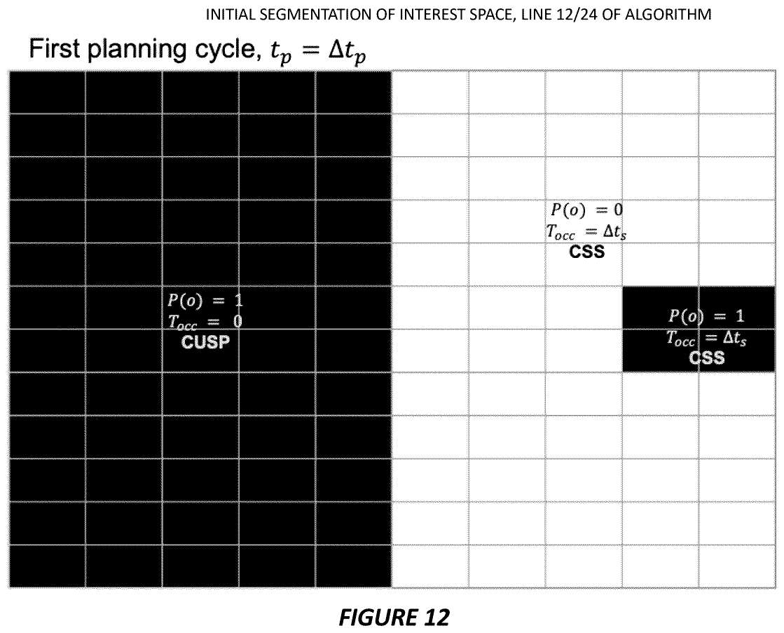

FIG. 12 illustrates that the first planning operation is a call to segment the interest space 16, based on the captured data. The cells represented in the captured data are classified as CSSp, with the remaining cells classified as CUSp.

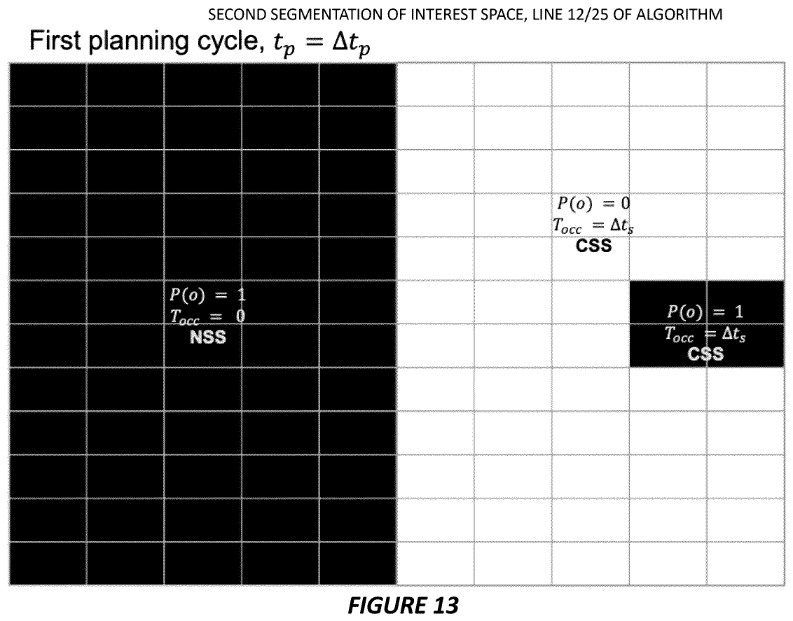

FIG. 13 illustrates a second pass of space classification, wherein the CUSp is refined into PSSp and NSSp. In the illustrated example, there is no PSSp.

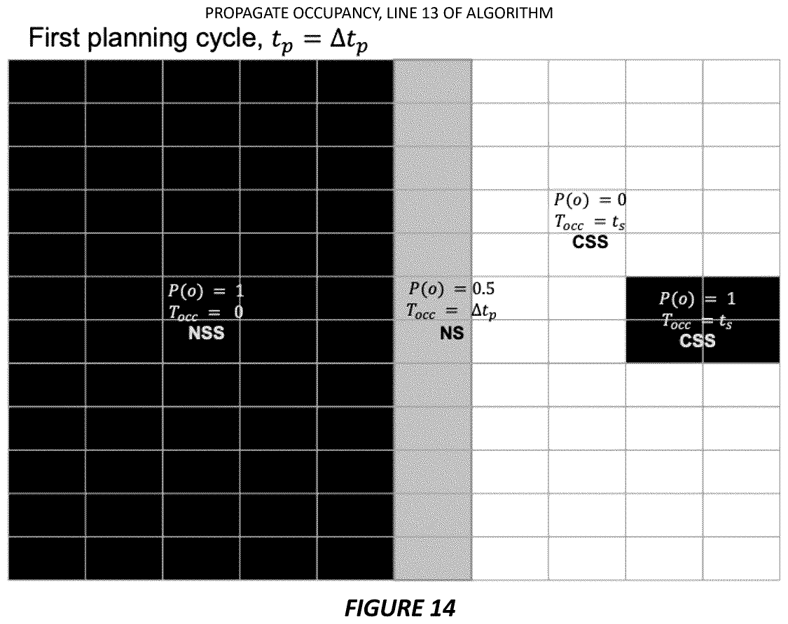

FIG. 14 illustrates a first propagation of occupancy from the NSSp into the CSSp, in which unoccupied cells of the CSSp at the boundary with the NSS are “converted” into NSp cells. Note that this conversion is a mathematical flow or propagation of the probability of occupancy from the bounding NSSp cells into the unoccupied, neighboring CSSp cells. In this example, the probability of occupancy of the involved NSSp cells was 1, and this value is propagated as a 0.5 probability of occupancy into the unoccupied neighboring CSSp cells.

This propagation example is one of multiple variations. A more aggressive propagation can be used, for example, to accommodate higher uncertainty about dynamic objects in the interest space 16 and/or to allow for higher maximum speeds of such dynamic objects. For example, the propagated value may be a 0.75, the propagation may extend further into the CSSp. In this regard, it should be understood that these cells are three dimensional and propagation “flows” in a three dimensional sense, e.g., along what might be considered a wavefront in three dimensional space.

No occupancy flow from the cells within the CSSp that were detected as occupied occurs in this example, because this example assumes a static classification applies to the detected object.

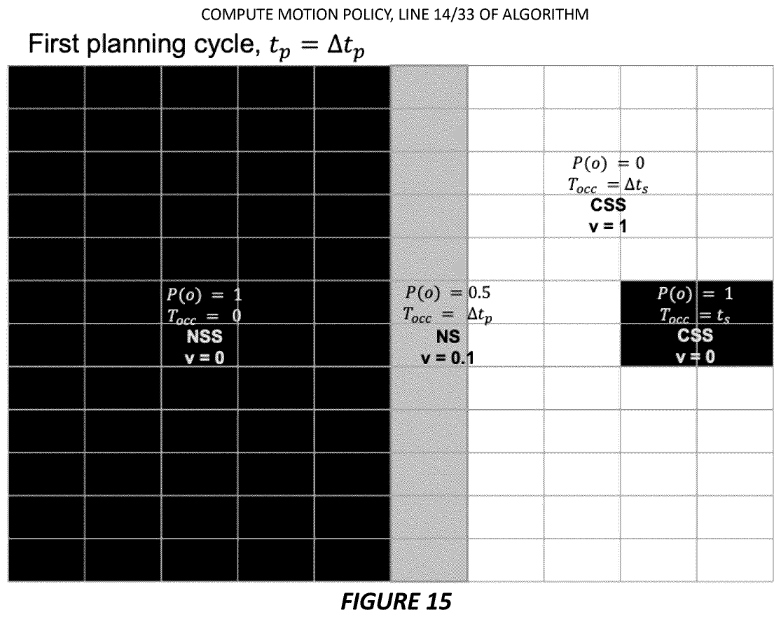

FIG. 15 illustrates the generation of constraints for motion policy computation. In other words, FIG. 15 stands as one example of generating differentiated values for one or more motion-planning parameters, to be used in an updated motion planning policy. In this particular example, a maximum speed (v) is set based on the segmentation of the interest space 16 and probability of occupancy, so as to maintain an acceptable level of risk during robot motion. One sees a maximum speed of 0 for cells having a probability of occupancy of 1, a maximum speed of 1 for unoccupied cells, and a maximum speed of 0.1 for cells having a probability of occupancy of 0.5. In other words, the motion planning policy used to plan the motion of the robot 10 in the interest space 16 is differentiated with respect to NSSp, NSp, and CSSp.

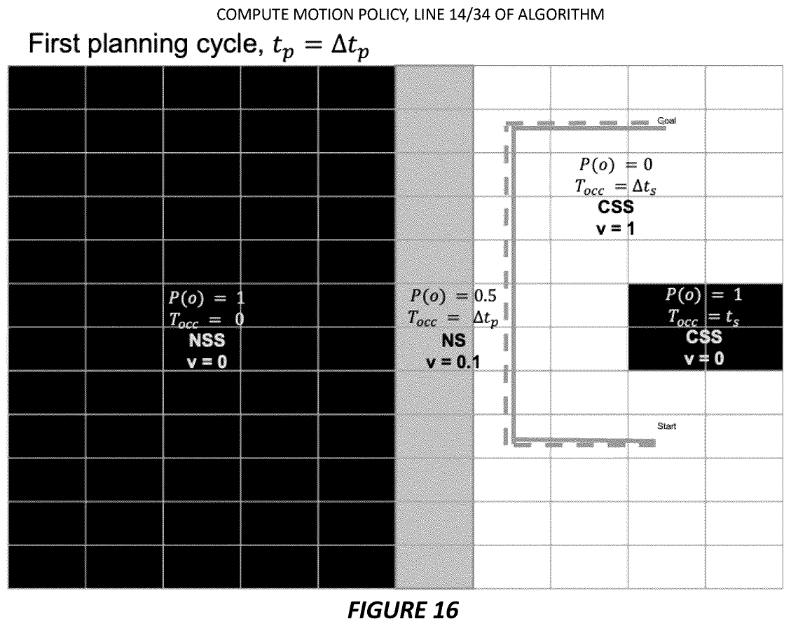

FIG. 16 illustrates generation of a motion plan for the robot 10 for moving the robot 10 from a starting pose to a goal pose, based on the updated motion planning policy. The dashed path line represents a “nominal” path that would be computed without benefit of the differentiated motion-planning parameter(s)—i.e., in the absence of occupancy flow—whereas the solid path line represents the path computed in accordance with the differentiated parameters. In this example case, the two paths are the same, as a consequence of the particular starting and goal posts, and the availability of a clear path through unoccupied cells of the CSSp.

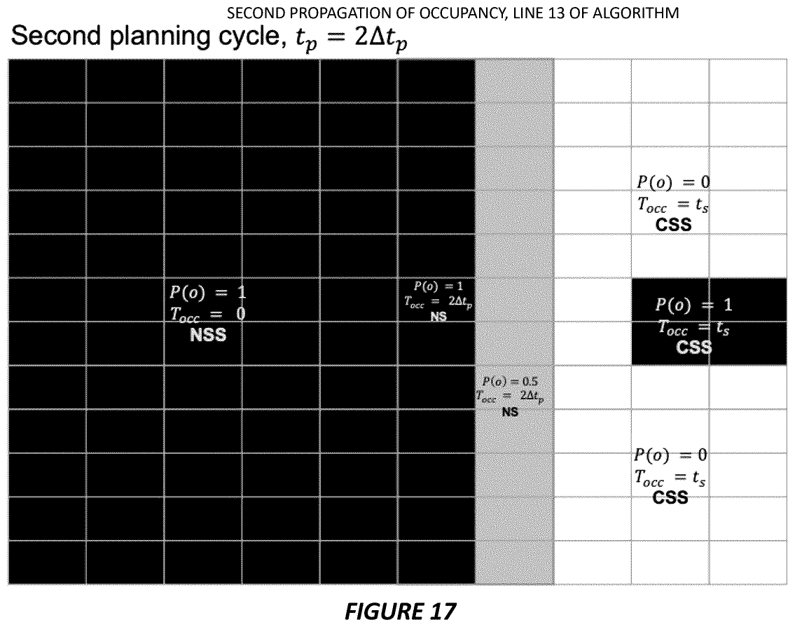

FIG. 17 illustrates the second propagation of occupancy from the same captured sensor data, i.e., tₛ=Δtₛ. Of particular interest, the NSp cells that had a probability of occupancy of 0.5 from the first propagation are updated to a probability of occupancy of 1, and a new band of NSp cells with a probability of occupancy of 0.5 is created. Thus, the NSp can be understood as growing again, at the expense of unoccupied cells in the CSSP. Also, with the lone obstacle detected in the CSSp being classified as static, now occupancy flows out from the CSSp cells corresponding to that detected object.

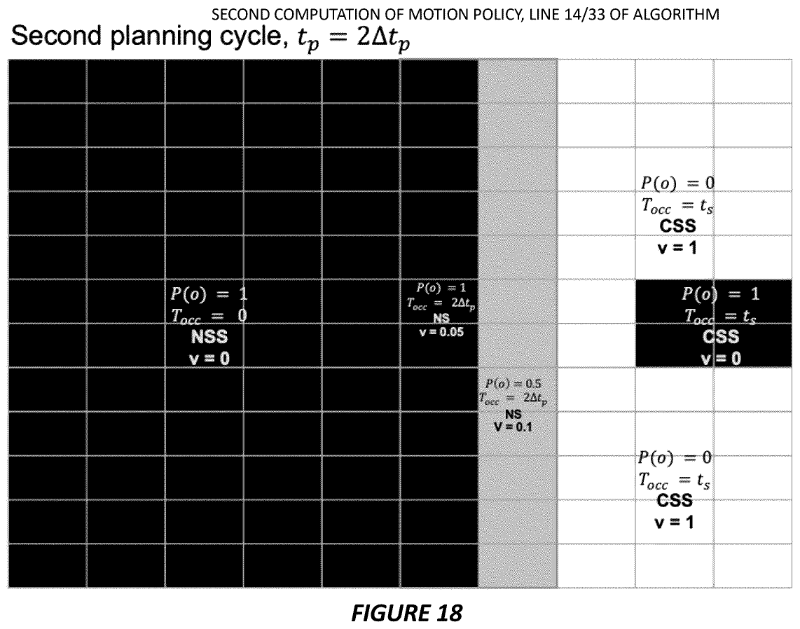

FIG. 18 illustrates a further update of the motion planning policy, where new or updated constraints are determined according to the occupancy changes arising from the second propagation of occupancy. In this example, the robot 10 is allowed to move with a very slow speed through NSp such that overall risk related to collisions with objects emerging from NSSp is kept within acceptable limits. Of course, the robot is not allowed to move through fully occupied cells in the CSSp, where “fully occupied” means a probability of occupancy of 1.

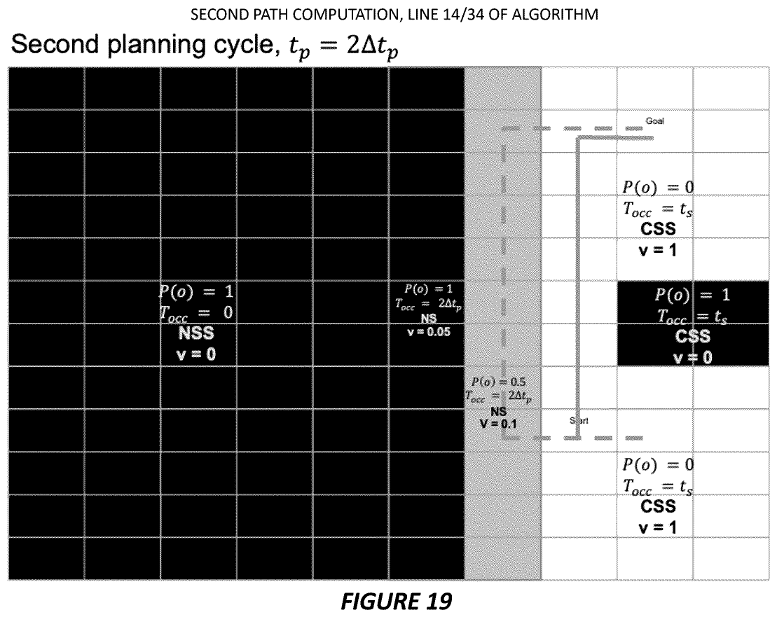

FIG. 19 illustrates computation of a motion path for the robot 10 according to the newly updated motion planning policy. The nominal motion path (dashed) would have had the robot 10 moving through a region with a significant speed constraint (v=0.1), whereas the computed path (solid) considers the differentiated speed constraints and it advantageously avoids traversing the NSp, i.e., it remains within the unoccupied cells of the CSSp where P(o)=0.

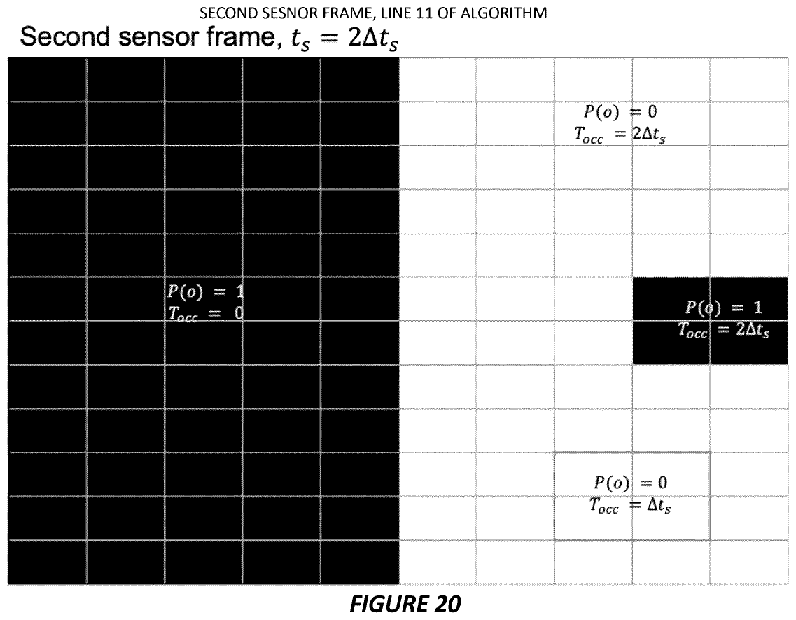

FIG. 20 illustrates acquisition of the next, second frame of sensor data, where, again, the left half of the interest space 16 is not sensed, and the right half of the interest space 16 is sensed. This new sensing erases or resets the propagated occupancies or put another way, the occupancy of cell that is sensed is reset based on the corresponding sensor data. Further in this example, a small portion of the interest space 16 that was sensed in the first sensor frame is not sensed in the second sensor frame.

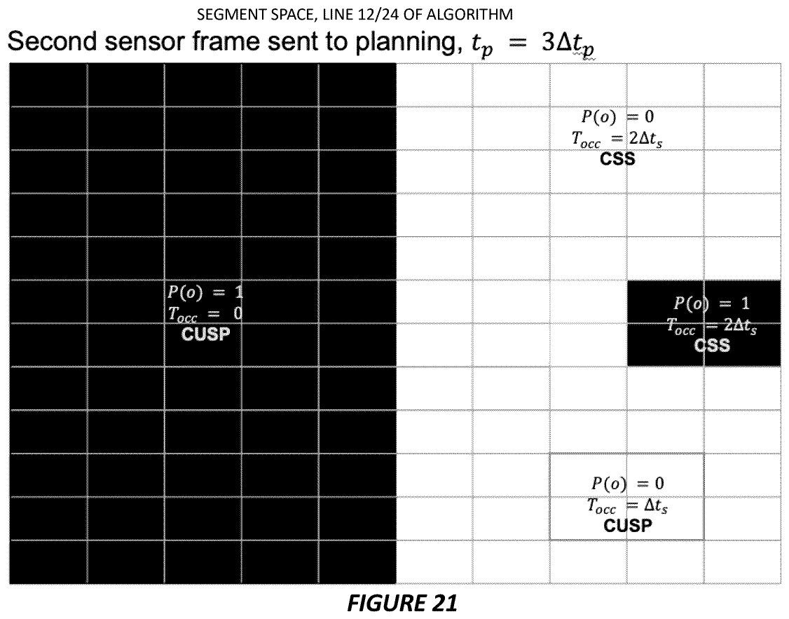

FIG. 21 illustrates the first pass or step of space segmentation resulting from capture of the second sensor frame, and FIG. 21 assumes that the same cells sensed in the first sensor frame are sensed in the second sensor frame, except for one small region. Hence, one sees that the left half of the interest space 16 is again classified as CUSp but now the otherwise continuous set of cells that constituted the CSSp for the first sensor frame includes a small region of CUSp.

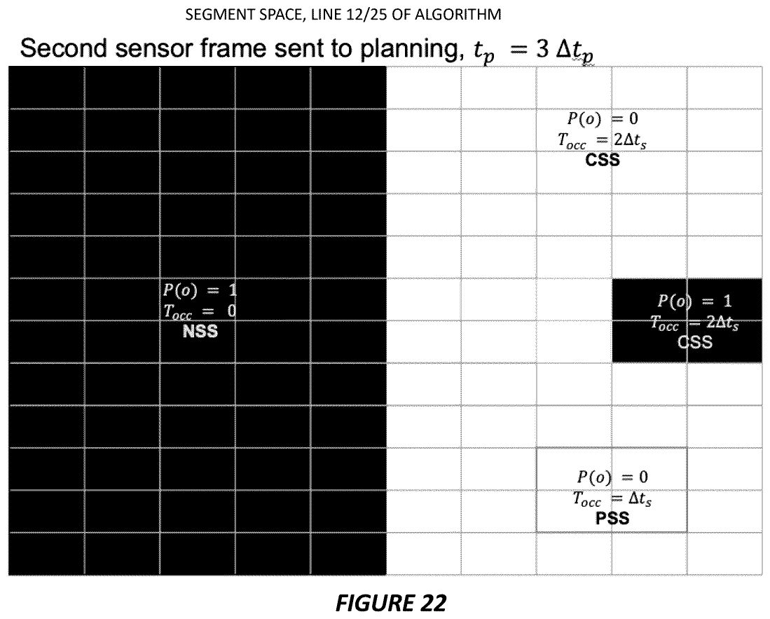

FIG. 22 illustrates the second pass or step of space classification in conjunction with the next step or cycle of motion planning, and one sees that the small regions of CUSp within the CSSp is classified as PSSp, based on T_{occ} being less than tₛ which is equal to 2Δtₛ for the second sensor frame. This further classification or classification refinement provides a basis for subclassifying CUSp as NSSp or PSSp.

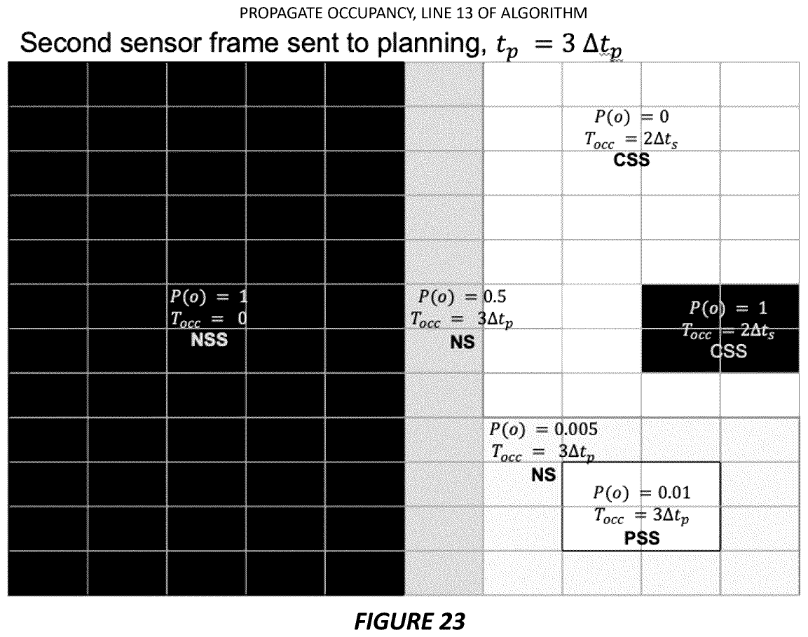

FIG. 23 illustrates the propagation of occupancy—occupancy flow—with respect to the second sensor frame. A key point to note here is that the occupancy flow process creates a region of NSp at the boundary between the NSSp and the CSSp and creates a bounding or surrounding region of NSp around the “island” of PSSp within the CSSp. Another point to reiterate is that creating NSp at the expense of CSSp involves only unoccupied regions within the CSSp—the propagation of occupancy for the creation of NSp does not overwrite any currently detected occupancy.

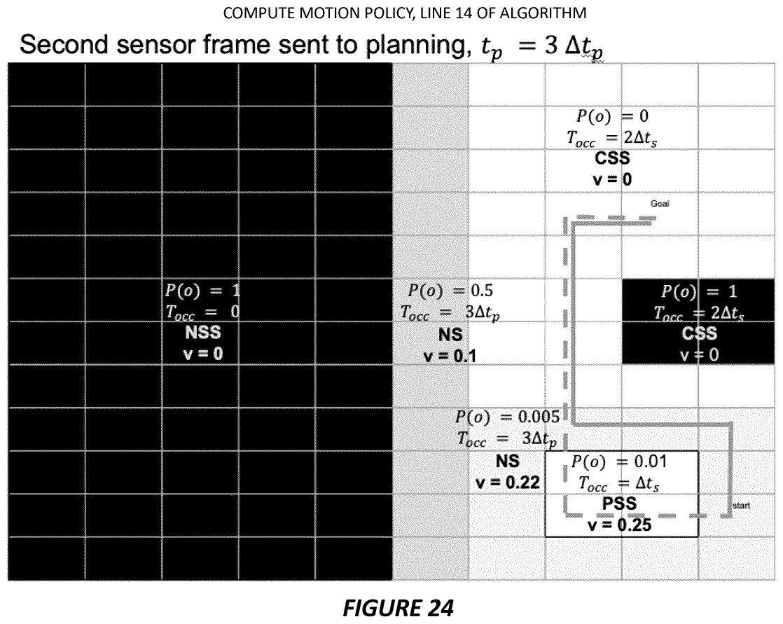

FIG. 24 illustrates updating the motion planning policy with respect to the space classifications and occupancy propagation seen in FIG. 23. One sees the use of a differentiated maximum speed parameter (v), such that different maximum speeds are allowed for movement of the robot 10 in NSp versus unoccupied regions of CSSp. More particularly, one sees that the mathematical, incremental propagation of occupancy used to create the NSp results in different regions within the NSp having different probabilities of occupancy. As such, the speed parameter and/or one or more other motion-control parameters may be differentiated even within NSp.

This idea of older and newer NSp can be understood as corresponding to the stepwise or incremental propagation of occupancy, resulting in a gradient of occupancy probability values over or within the NSp. For example, the oldest region(s) of NSp may have a higher probability of occupancy than the newest region(s) of NSp. Thus, “older” and “newer” relate to executing successive occupancy flow procedures with respect to a single sensor data capture, for the incremental propagation of occupancy during the interval leading to the next capture of sensor data.

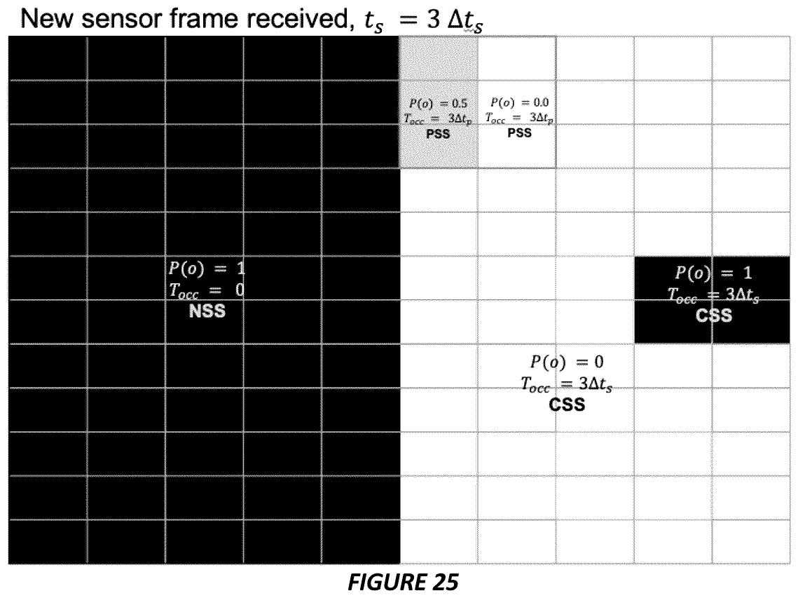

FIG. 25 illustrates the capture of the next sensor data frame, which is the third capture taken over the processing flow represented by FIGS. 9-25. FIG. 25 again assumes that the left half of the interest space 16 is not sensed and that the right half of the interest space 16 is sensed, except that the small island of CUSp within the CSSp shown in FIG. 20 is sensed in the third capture. However, another portion or region of what was CSSp in the context of FIGS. 20 and 21 is not sensed in the third capture, such that it becomes classified as PSSp and the previously propagated probability of occupancy is retained for that portion of PSSp that was converted to NSp with respect to the second sensor frame.

With the foregoing details in mind, at least one embodiment disclosed herein comprises a method for planning robot motions in an environment that is not fully observed at any time and has dynamic objects. The method (a) segments the interest space according to what is seen and unseen via the involved sensor(s), (b) creates a further class of space referred to as near space by propagating assumed occupancy from unseen space into seen space, and (c) performs motion planning according to observed, assumed, and propagated occupancies, based on a motion planning policy that is differentiated on the basis of the space segmentation.

Segmentation defines occupancy propagation and makes it possible to establish segment-based definitions (rules, equations) that at least partially define occupancy propagation; for example, the computer apparatus 30 may be programmed to follow or establish rules that define how occupancy propagates, including from one segment to another. Segmentation also defines the motion planning policy; that is, the space segmentation described herein makes it possible for the motion planning policy to be segment-based (and potentially also based on other factors, like probability of occupancy).

An example motion planning policy includes one or more rules that are differentiated as a function of the segmentation. In a more complex example, motion planning may use continuous numbers that may be a function of the segmentation. These differentiations reflect risk and uncertainty associated with objects moving into seen space subsequent to the most recent observation of that space. Of course, motion planning may consider segmentation and probability of occupancy.

Motion planning is often concerned generally with risk and uncertainty, and this can be represented by a single number (e.g. a probability) or a more complex representation (e.g., a probability and other factors). These other factors can be a function of the involved segment (e.g. each logical segment of interest space as described herein gets a potentially different probability distribution model), and therefore how probability is interpreted into uncertainty and motion plans can be a function of the segmentation. For example, a 0.5 probability in NS may result in different motion planning than 0.5 probability in PSS, due to these additional segment-based factors.

CUSP-based segmentation as disclosed herein is particularly valuable in applications where the environment—the interest space 16—is sufficiently known to plan paths but it is difficult to guarantee collision avoidance of trajectories due to the potential motion of dynamic objects, such as humans. In one or more of the targeted applications, the robot 10 needs to reduce the likelihood of unintended contact (both unsafe collisions and collisions in general) while continuing to perform functional aspects of its task(s) in a dynamically changing and unpredictable environment (e.g. a human-oriented environment). Two specific issues arise in these applications that make collision avoidance challenging: 1) occlusions and 2) dynamic objects.

In real-world applications executed by the robot 10, parts of the interest space 16 may not be currently visible to the sensor(s) 18 that are utilized for automatic planning: sensors that are used for planning robot motions typically have blind spots or other limitations resulting in portions of the interest space 16 that cannot be directly sensed at any given instant in time. Limitations include FoV limits, occlusions due to other objects in the environment, and self-occlusions due to the robot 10. Collectively, all such limitations typically result in less than all of the interest space 16 being observable at any given moment in time.

When the interest space 16 is also expected to change with time (e.g. due to dynamic objects such as humans, or movable objects such as a bottle or cup), any occupancy information acquired via the sensor(s) 18 becomes stale and may be invalid at a later time, resulting in collision risks between the robot 10 and objects in CSSp (including humans). Such occlusion-related challenges are further exacerbated by systems that use only “in-system sensors”, which are integrated into the workcell. Here, an “in-system sensor” is one that is integrated into the robot application, and “workcell” refers to the preconfigured arrangement of the robot 10 and any end effector, fixtures, structure, and other components which are necessary for system functionality. Example work cells include arrangements of equipment that stay in one floor location. Other examples involve mobile manipulators (MoMa), e.g., robotic arms attached to mobile bases.

One advantage, however, of in-system sensors is that they eliminate the need to externally mount sensors in the environment, making the overall setup of the system easier. Techniques disclosed herein enable easy-to-setup robot systems in targeted applications by reducing the risk of unintended collisions while not requiring external or otherwise additional sensors for elimination of blind spots within the interest space 16. More broadly, the disclosed techniques relate to the problem of robot perception, motion planning and collision avoidance in applications where a robot manipulator needs to share its reachable workspace with dynamic objects such as humans and other robots. Such applications include human-oriented environments such as industrial automation, laboratory automation, and service sector robotics (e.g. hospital, food service, laundry service, home, kitchen, and personal assistance applications).

Past approaches address the problem of occlusions by using exploration strategies. However, these older solutions generally assume the absence of dynamic objects in the environment. As a result, such solutions result in an unacceptable collision risk in applications involving dynamic environments, e.g., environments with humans and/or other robots.

Among the several advantages of the techniques disclosed herein is lower cost, with the lower costs resulting from ease of setup and obviation of the need to ensure that the involved interest space 16 is fully observed at each observation cycle. Another advantage is flexibility and automatic adaptation. These attributes flow from the fact that a computer apparatus 30 configured as disclosed herein automatically and dynamically classifies (segments) different portions of the interest space 16 based on what is seen and not seen at successive observations, and further based on the propagation of assumed probabilities of occupancy from NSSp into CSSp and PSSp, according to ongoing occupancy propagation, which is also referred to as occupancy diffusion to highlight the gradated nature of occupancy probabilities during NS formation.

The propagation process effectively creates a dynamically growing buffer region of NS between given CSS or PSS and adjacent NSS, with motion planning being differentiated with respect to the gradated occupancy probabilities associated with the NS, resulting, for example, in more restrictive velocity limits in NS as compared to unoccupied regions of CSS. Such an arrangement can be understood as creating a logical zone or buffer region around or adjacent to seen space that grows at the expense of the seen space as the corresponding sensor data ages. This safety zone reflects the fact that in a dynamic environment, a human or other object may encroach into the CSS since the corresponding time of data acquisition.

As one example of computing a motion planning policy based on dynamic space segmentation, including the dynamic creation of NS as a function of the occupancy diffusion process, assume that motion policies are represented using trajectories and that no nominal motion planning policy is provided (if one is provided, then is serves as an input to step 3 below).

The following steps are involved for creation of a motion planning policy that is differentiated as a function of dynamic space segmentation, according to an example embodiment: (1) take as input a goal pose (or path) that is inside NS; (2) generate an initial trajectory for the robot 10 from the start pose to the goal pose; (3) use a trajectory optimization method to find a trajectory that avoids NSS and obstacles in CSS; and (4) use a trajectory speed scaling method to reduce the speed of the trajectory such that speed constraints for movement of the robot 10 in NS are satisfied. Flexible points to note here are that the same occupancy value may be handled differently by the motion planning policy in dependence on the classification of the involved voxel or three-dimensional point. For example, the motion planning policy in one example disallows encroachment of the robot 10 into NSS while allowing motion at a reduced speed in NS separating the NSS from given regions of CSS or PSS.

One or more embodiments use the following set of rules for occupancy diffusion:
(1) Probability of occupancy can flow from and to all regions except when a region is categorized as static (i.e., motion_type=static). Recall that: all NSS and NS is assumed to have dynamic motion type; CSS and PSS can have dynamic or static motion types. As a special case for computational efficiency, the following rule can be appended to #1: (2) Probability of occupancy can flow only from a region of high probability of occupancy to low probability of occupancy, with the goal of reducing the number of computations.

In one or more embodiments, the factors defining the occupancy propagation or flow are: (1) the time difference between each motion planning cycle (Δtₚ); (2) the response time of the robot 10 for any motion related command issued to it; (3) the time difference between when sensor data is acquired and the time step at which occupancy is being computed (Δtₛ); (4) the size of the cells (s_{cell}), which can also be understood as the voxel resolution—i.e., how finely the interest space 16 is subdivided for purposes of dynamic space segmentation and the corresponding labeling and occupancy-value management; and (5) the assumed speed of dynamic objects (v_{dyn})—i.e., an assumed speed of moving objects, such as humans, which affects how quickly sensor data becomes stale.

Using the above parameters, the number of cells over which diffusion (occupancy propagation) occurs over a single motion planning cycle can be computed as

$${n}_{diff} = ceil ( {v}_{dyn} Δ {t}_{p} / {s}_{cell} ) \qquad ( Eq . 1 )$$

Using Eq. 1 the occupancy O of a cell i can be computed as below for a 1D grid as

$${O}_{cell} ( i ) = {O}_{sensor} ( i ) + {c}_{diff} ( Δ {t}_{s} ) {O}_{diff} ( i ) \qquad ( Eq . 2 )$$

$${O}_{diff} ( i ) = max ( {\sum }_{j = i - {n}_{diff}}^{i + {n}_{diff}} w ( j , seg ( j ) , motion\_type ( j ) ) {o}_{cell} ( j ) , 1 ) \qquad ( Eq . 3 )$$

Of course, such computations directly extend to 3D diffusion.

In the above equations, w(j,seg(j),motion_type(j)) is computed as function of the segmentation seg(j) of the cell j and based on the motion type associated with cell j, motion_type(j). The motion type of a cell can be either dynamic or static. For cells with motion_type=static, w is set to 0. The term Oₛₑₙₛₒᵣ is the occupancy of the cell based on the sensor data, c_{diff}(Δtₛ) is a coefficient used to turn off and turn on the propagation process and is set to 0 if Δtₛ=0 and is 1 otherwise. For a simple 1D example, the size of the diffusion influence over a single motion planning cycle would be (2n_{diff}+1). In at least one embodiment, the occupancy propagation process as described herein is achieved with a convolution operation where the weights w(j) form the kernel of the convolution operation.

The disclosed techniques apply to robots that operate in a fixed location and to mobile robots, including mobile manipulators. Further, while example operations of dynamic space segmentation and the corresponding differentiation of motion planning policy involve the use of logical labeling—i.e., CUSP, CSS, PSS, NS—other embodiments generate differentiated motion constraints directly based on the age of the sensor data corresponding to specific region of the workspace, rather than according to the discrete labels logically applied to different regions of the interest space 16.

Along such lines, at least one embodiment involves “forgetting” acquired occupancy data according to an aging timeline, that an observed region of the interest space 16 over time reverts back to NSS, assuming no subsequent reobservation occurs within some defined aging timeline. A variation of such operation involves considering a given region of the interest space 16 as a mix of PSS and NSS, with the gradually increasing weighting as NSS. Also, as noted, one or more embodiments consider the risk of unsafe quasi-static contact in addition to the risk of unsafe collisions.

In one or more embodiments, the robot 10 or the associated computer apparatus 30 is configured to reposition one or more movable in-system sensors 18 to increase CSS along desired motion directions that contain volumes occupied by the robot 10 (e.g. end effectors, parts, dress packs) associated with the desired motion.

Further, one or more embodiments use an occupancy threshold to determine the segmentation into NS. At least one embodiment uses subclassifications of NS, such that there are logical subclasses of near previously seen space (NPSSp) and near never seen space (NNSSp), with differentiated occupancy propagation used in dependence on whether occupancy is diffusing from NPSSp versus NNSSp. Similarly, one or more aspects of the motion planning policy may be differentiated in dependence on whether the robot 10 is moving (or will move) in NPSSp versus NNSSp.

Still further, one or more embodiments incorporate into the motion planning policy additional risk related to factors other than collision. For example, the motion planning policy may consider any one or more of the risk of spills while handling liquids, objects falling, psychological safety and risks related to handling movable objects like drawers and doors.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method of performing real-time motion planning for movement of a robot, the method comprising:
performing a sensor data capture in which occupancy of a first portion of the motion planning space is observed as currently seen space (CSSp), and a remaining, second portion of the motion planning space is unobserved as currently unseen space (CUSp);
performing an occupancy flow process to account for possible incursions of dynamic objects from the CUSp into unoccupied regions of the CSSp during a time lag between computation of an updated motion plan for the robot and corresponding incremental movement of the robot in accordance with the updated motion plan, the occupancy flow process creating one or more bounding regions of near space (NSp) at the expense of the CSSp, based on a mathematical propagation of probabilities of occupancy from the CUSp into the CSSp;
updating a motion planning policy that applies one or more differentiated motion-planning parameters that are differentiated as a function of the logical classifications of the motion planning space into CUSp, CSSp, and NSp; and
computing the updated motion plan for the robot, based on the updated motion planning policy.

2. The method according to claim 1, further comprising moving the robot in the motion planning space according to the updated motion plan.

3. The method according to claim 2, wherein moving the robot in the motion planning space according to the updated motion plan comprises driving one or more motion actuation systems of the robot according to values of the one or more motion planning parameters that are differentiated as between movement within the CSSp versus movement within any of the one or more bounding regions of NSp.

4. The method according to claim 1, wherein the one or more differentiated motion-planning parameters include a speed parameter having a first value applicable to movement of the robot in the CSSp, and a lower, second value applicable to movement of the robot in the NSp, and wherein the method includes applying the second value of the speed parameter when moving the robot in the NSp.

5. The method according to claim 4, wherein computing the updated motion plan for the robot comprises determining whether or to what extent an overall motion path for the robot includes any of the one or more bounding regions of NSp, based on balancing an overall path traversal time against one or both of path distance and path complexity.

6. The method according to claim 1, wherein the one or more differentiated motion planning parameters comprise a motion planning parameter having a first value associated with the CSSp, the first value allowing movement of the robot within the CSSP, and having a second value associated with the one or more bounding regions of NSp, the second value disallowing movement of the robot within the one or more bounding regions of NSp, and wherein computing the updated motion plan for the robot comprises determining a motion path that is constrained to movement within the CSSp.

7. The method according to claim 1, wherein the method further comprises:
classifying any particular region in the CSSp as an occupied region or an unoccupied region, in dependence on corresponding sensor data captured for that particular region; and
classifying each occupied region as being dynamic or static, in dependence on one or both of configuration data and historical sensor data obtained from prior performances of sensor data capture; and
wherein creating the one or more bounding regions of NSp further comprises, for each dynamic region in the CSSp, creating a corresponding bounding region of NSp that partially or wholly surrounds the dynamic region.

8. The method according to claim 7, wherein updating the motion planning policy comprises setting a particular motion planning parameter to a first value for occupied regions in the CSSp, and to a second value for unoccupied regions in the CSSp.

9. The method according to claim 8, further comprising assigning an occupancy probability of 1 to each dynamic region in the CSSp, such that the corresponding bounding region of NSp has a probability of occupancy derived from the occupancy of probability of 1.

10. The method according to claim 1, further comprising classifying regions of the CUSp as never seen space (NSSp) or as previously seen space (PSSp), in dependence on whether or how recently sensor data was captured with respect to such regions, and wherein performing the occupancy flow process differentiates between NSSp and PSSp in that the probabilities of occupancy for NSSp depend on a configured default probability of occupancy, while probabilities of occupancy for each PSSp depend on observed occupancies determined from a most recent capture of sensor data performed with respect to the corresponding region.

11. The method according to claim 1, wherein performing the sensor data capture comprises performing one iteration of a cyclic data capture procedure performed on an ongoing basis, wherein performing the occupancy flow process comprises performing one iteration of a cyclic occupancy propagation procedure performed on an ongoing basis, wherein each new iteration of the cyclic data capture procedure establishes a new CSSp that persists as a current CSSp until the next iteration of the cyclic data capture procedure, and wherein each new iteration of the cyclic occupancy propagation procedure acts on the current CSSp.

12. The method according to claim 11, wherein updating the motion planning policy comprises performing one iteration of a cyclic motion planning procedure, and wherein each iteration of the cyclic occupancy propagation procedure is accompanied by a corresponding iteration of the cyclic motion planning procedure.

13. The method according to claim 12, wherein a periodicity of the cyclic motion planning procedure and the cyclic occupancy propagation procedure is faster than a periodicity of the cyclic data capture procedure, such that the current CSSp is subjected to two or more successive iterations of the cyclic occupancy propagation procedure, with each succeeding iteration growing the one or more bounding regions of NSp at the expense of the current CSSp.

14. The method according to claim 1, wherein performing the sensor data capture comprises obtaining at least one of: obtaining image data from one or more cameras operative to image one or more corresponding portions of the motion planning space as said CSSp; obtaining LIDAR data from one or more LIDAR sensors operative to scan one or more corresponding portions of the motion planning space as said CSSp.

15. A computer apparatus configured to perform real-time motion planning for movement of a robot, the computer apparatus comprising:
interface circuitry; and
processing circuitry configured to:
perform, via the interface circuitry, a sensor data capture in which occupancy of a first portion of the motion planning space is observed as currently seen space (CSSp), and a remaining, second portion of the motion planning space is unobserved as currently unseen space (CUSp);
perform an occupancy flow process to account for possible incursions of dynamic objects from the CUSp into unoccupied regions of the CSSp during a time lag between computation of an updated motion plan for the robot and corresponding incremental movement of the robot in accordance with the updated motion plan, the occupancy flow process creating one or more bounding regions of near space (NSp) at the expense of the CSSp, based on a mathematical propagation of probabilities of occupancy from the CUSp into the CSSp;
update a motion planning policy that applies one or more differentiated motion-planning parameters that are differentiated as a function of the logical classifications of the motion planning space into CUSp, CSSp, and NSp; and
compute the updated motion plan for the robot, based on the updated motion planning policy.

16. The computer apparatus according to claim 15, wherein the processing circuitry is configured to move the robot in the motion planning space according to the updated motion plan, based on being configured to drive one or more motion actuation systems of the robot according to values of the one or more motion planning parameters that are differentiated as between movement within the CSSp versus movement within any of the one or more bounding regions of NSp.

17. The computer apparatus according to claim 15, wherein the one or more differentiated motion-planning parameters include a speed parameter having a first value applicable to movement of the robot in the CSSp, and a lower, second value applicable to movement of the robot in the NSp, and wherein the processing circuitry is configured to apply the second value of the speed parameter when moving the robot in the NSp.

18. The computer apparatus according to claim 17, wherein, for computing the updated motion plan for the robot, the processing circuitry is configured to determine whether or to what extent an overall motion path for the robot includes any of the one or more bounding regions of NSp, based on balancing an overall path traversal time against one or both of path distance and path complexity.

19. The computer apparatus according to claim 15, wherein the one or more differentiated motion planning parameters comprise a motion planning parameter having a first value associated with the CSSp, the first value allowing movement of the robot within the CSSP, and having a second value associated with the one or more bounding regions of NSp, the second value disallowing movement of the robot within the one or more bounding regions of NSp, and wherein, for computing the updated motion plan for the robot, the processing circuitry is configured to determine a motion path that is constrained to movement within the CSSp.

20. The computer apparatus according to claim 15, wherein the processing circuitry is further configured to:
classify any particular region in the CSSp as an occupied region or an unoccupied region, in dependence on corresponding sensor data captured for that particular region; and
classify each occupied region as being dynamic or static, in dependence on one or both of configuration data and historical sensor data obtained from prior performances of sensor data capture; and
wherein, for creating the one or more bounding regions of NSp, the processing circuitry is further configured to, for each dynamic region in the CSSp, create a corresponding bounding region of NSp that partially or wholly surrounds the dynamic region.

21. The computer apparatus according to claim 15, wherein the processing circuitry is configured to classify regions of the CUSp as never seen space (NSSp) or as previously seen space (PSSp), in dependence on whether or how recently sensor data was captured with respect to such regions, and wherein the occupancy flow process differentiates between NSSp and PSSp in that the probabilities of occupancy for NSSp depend on a configured default probability of occupancy, while probabilities of occupancy for each PSSp depend on observed occupancies determined from a most recent capture of sensor data performed with respect to the corresponding region.

22. The computer apparatus according to claim 15, wherein the processing circuitry is configured to perform the sensor data capture as one iteration of a cyclic data capture procedure that is performed on an ongoing basis, and perform the occupancy flow process as one iteration of a cyclic occupancy propagation procedure that is performed on an ongoing basis, wherein each new iteration of the cyclic data capture procedure establishes a new CSSp that persists as a current CSSp until the next iteration of the cyclic data capture procedure, and wherein each new iteration of the cyclic occupancy propagation procedure acts on the current CSSp.

23. The computer apparatus according to claim 22, wherein, for updating the motion planning policy, the processing circuitry is configured to perform one iteration of a cyclic motion planning procedure, and wherein each iteration of the cyclic occupancy propagation procedure is accompanied by a corresponding iteration of the cyclic motion planning procedure.

24. The computer apparatus according to claim 23, wherein a periodicity of the cyclic motion planning procedure and the cyclic occupancy propagation procedure is faster than a periodicity of the cyclic data capture procedure, such that the current CSSp is subjected to two or more successive iterations of the cyclic occupancy propagation procedure, with each succeeding iteration growing the one or more bounding regions of NSp at the expense of the current CSSp.
